(19) United States
(12) Patent Application Publication
(10) Pub. No.: US 2013/0072212 A1
(43) Pub. Date: Mar. 21, 2013

(54) RADIO COMMUNICATION SYSTEM, RADIO BASE STATION, AND COMMUNICATION CONTROL METHOD

(71) Applicants: Kazutaka Nakamura, Yokohama-shi (JP); Chiharu Yamazaki, Ota-ku (JP); Taku Nakayama, Yamato-shi (JP); Shingo Joko, Kawasaki-shi (JP); Yoshimasa Kusano, Yokohama-shi (JP)

(72) Inventors: Kazutaka Nakamura, Yokohama-shi (JP); Chiharu Yamazaki, Ota-ku (JP); Taku Nakayama, Yamato-shi (JP); Shingo Joko, Kawasaki-shi (JP); Yoshimasa Kusano, Yokohama-shi (JP)

(73) Assignee: KYOCERA CORPORATION, Kyoto (JP)

(21) Appl. No.: 13/700,116

(22) PCT Filed: May 27, 2011
(86) PCT No.: PCT/JP2011/062276

§ 371 Date: Nov. 26, 2012

(30) Foreign Application Priority Data
May 27, 2010 (JP) 2010-122141

(51) Int. Cl. H04W 72/04

(52) U.S. Cl. 455/452.1

(57) ABSTRACT

A radio base station eNB10-1 sends a Resource Status Request message for requesting initiation of transmission of a second load information to a radio base station eNB10-2 when a load level thereof is equal to or higher than a first threshold, and omits transmission of the Resource Status Request message for requesting initiation of transmission of the second load information when the load level thereof is lower than the first threshold. The radio base station eNB10-2 sends a Resource Status Update message including the second load information upon receipt of the Resource Status Request message for requesting initiation of transmission of the second load information.

### TECHNICAL FIELD

The present invention relates to a radio communication technique, and more particularly relates to a radio communication system, a radio base station, and a communication control method capable of adjusting coverage.

### BACKGROUND ART

In LTE (Long Term Evolution) standardized in 3GPP (3rd Generation Partnership Project) which is a standardization organization for radio communication systems, techniques called SON (Self Organizing Network) are employed. A SON is expected to automate measurement and settings in fields without requiring human intervention for installation and maintenance of a radio base station (see Non-Patent Document 1, for example).

In a SON, there is proposed a method by which coverage is adjusted according to load information exchanged between radio base stations (referred to as “eNB” in 3GPP) in order to balance load between the radio base stations. Such an optimization technique is referred to as MLB (Mobility Load Balancing).

Specifically, in an LTE system, the following load information is defined. (a) Usage of PRBs (Physical Resource Blocks), each of which being a unit for time-frequency resource allocation, (b) load of backhaul between a radio base station and a core network, (c) hardware load of a radio base station, and (d) capacity class being an index of relative communication capacity of a radio base station, and a ratio of available communication capacity to the communication capacity.

### CITATION LIST

### Non-Patent Literature

Non-Patent Literature 1: 3GPP TR 36.902 V9.1.0, March 2010

### SUMMARY OF THE INVENTION

However, in the method of adjusting coverage according to load information, load information is exchanged between radio base stations at all times. Accordingly, load increases in the transmission paths as backhauls between the radio base stations.

Against this background, an objective of the present invention is to provide a radio communication system, a radio base station, and a communication control method capable of reducing load in transmission paths between radio base stations.

In order to solve the aforementioned problem, the present invention has following characteristics.

The characteristic of the present invention is summarized as follows. A radio communication system (radio communication system 1) comprises a first radio base station (radio base station eNB10-1) and a second radio base station (radio base station eNB10-2) each being capable of adjusting coverage according to its own load and load of the other radio base station, the first radio base station comprising: a first transmitter (X2 interface communication unit 140) configured to send, to the second radio base station, load request information for requesting load information indicating a load level of the second radio base station; and a first transmission controller (transmission controller 122) configured to control the first transmitter, wherein the first transmission controller controls the first transmitter so that the load request information is sent to the second radio base station when a load level of the first radio base station is equal to or higher than a first threshold, and controls the first transmitter so that transmission of the load request information to the second radio base station is omitted when the load level of the first radio base station is lower than the first threshold, the second radio base station comprising: a second transmitter (X2 interface communication unit 240) configured to send, to the first radio base station, the load information indicating the load level of the second radio base station; and a second transmission controller (transmission controller 222) configured to control the second transmitter, wherein upon receipt of the load request information, the second transmission controller controls the second transmitter to send the load information to the first radio base station.

According to such a characteristic, the first radio base station sends the load request information for requesting transmission of the load information indicating the load level of the second radio base station to the second radio base station when the load level of the first radio base station is equal to or higher than a first threshold, and omits transmission of the load request information when the load level of the first radio base station is less than the first threshold. Meanwhile, upon receipt of the load request information, the second radio base station sends the load information indicating the load level of the second radio base station to the first radio base station. Thus, transmission and reception of the load request information and the load information are omitted when the load level of the first radio base station is low and its coverage need not be adjusted. Accordingly, it is possible to reduce load in the transmission paths between the radio base stations.

The characteristic of the present invention is summarized as follows. A radio base station capable of adjusting coverage according to its own load and load of other radio base station, comprises: a transmitter configured to send, to the other radio base station, load request information for requesting load information indicating a load level of the other radio base station; and a transmission controller configured to control the transmitter, wherein the transmission controller controls the transmitter so that the load request information is sent to the other radio base station when its own load level is equal to or higher than a first threshold, and controls the transmitter so that transmission of the load request information to the other radio base station is omitted when its own load level is lower than the first threshold.

The characteristic of the present invention is summarized as follows. The first threshold is a value lower than a load level at which the radio base station is stably operable.

The characteristic of the present invention is summarized as follows. The smaller the number of radio terminals connected to the radio base station is, the higher the transmission controller sets the first threshold is.

The characteristic of the present invention is summarized as follows. When the load level of the radio base station becomes lower than a second threshold after transmission of the load request information, the transmission controller controls the transmitter to send stoppage request information for requesting stoppage of transmission of the load information to the other radio base station.

The characteristic of the present invention is summarized as follows. A communication control method used by a radio base station capable of adjusting coverage according to its own load and load of another radio base station, comprises the steps of: sending, to the other radio base station, load request information for requesting load information indicating a load level of the other radio base station; and controlling transmission of the load request information, wherein in the step of controlling transmission of the load request information, the control is performed so that the load request information is sent to the other radio base station when the load level of the radio base station is equal to or higher than a first threshold, and the control is performed so that transmission of the load request information to the other radio base station is omitted when the load level of the radio base station is lower than the first threshold.

### BRIEF DESCRIPTION OF THE DRAWINGS

FIG. 1 is a view for describing an outline of an LTE system of an embodiment of the present invention.

FIG. 2 is a schematic configuration diagram of a radio communication system of the embodiment of the present invention.

FIG. 3 is a block diagram showing a configuration of the first radio base station of the embodiment of the present invention.

FIG. 4 is a block diagram showing a configuration of the second radio base station of the embodiment of the present invention.

FIG. 5 is an operation sequence chart showing a first operation of the radio communication system of the embodiment of the present invention.

FIG. 6 is an operation sequence chart showing a second operation of the radio communication system of the embodiment of the present invention.

FIG. 7 is a schematic configuration diagram of a radio communication system of another embodiment.

### DESCRIPTION OF THE EMBODIMENTS

Next, with reference to the drawings, embodiments of the present invention are described. Specifically, the description is given in order of (1) Outline of LTE System, (2) Configuration of Radio Communication System, (3) Configuration of First Radio Base Station, (4) Configuration of Second Radio Base Station, (5) Operation of Radio Communication System, (6) Effects and Advantages, and (7) Other Embodiments. In the drawings of the embodiments, the same or similar reference numerals are applied to the same or similar parts.

### (1) Outline of LTE System

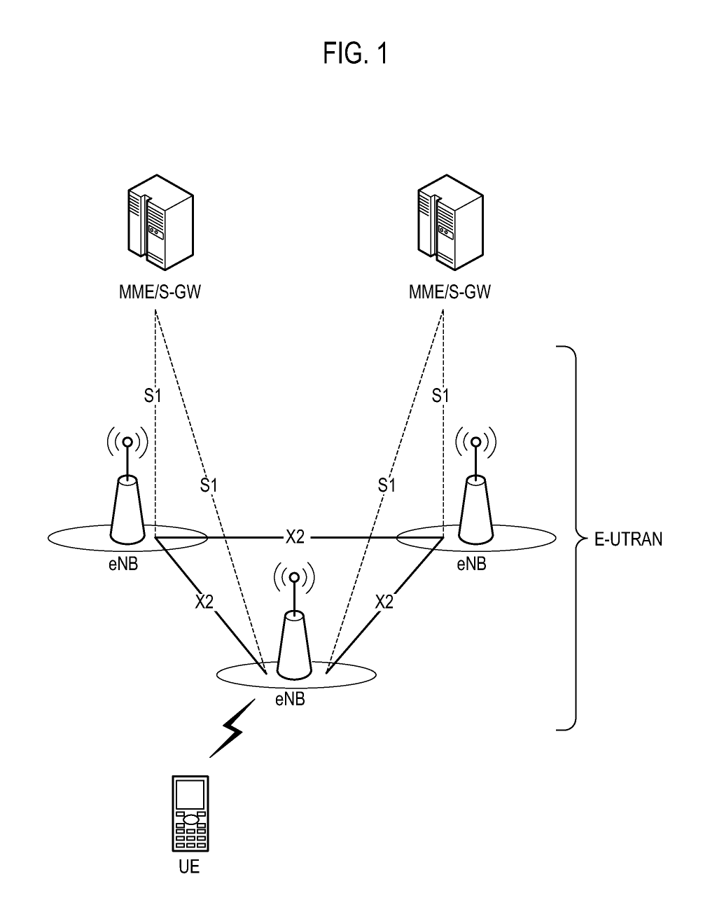

FIG. 1 is a view for describing an outline of an LTE system.

As shown in FIG. 1, multiple radio base stations eNB form an E-UTRAN (Evolved-UMTS Terrestrial Radio Access Network). Each of the multiple radio base stations eNB forms a cell which is a communication area for providing a service to radio terminals UE.

A radio terminal UE is a radio communication device held by a user, and is also referred to as a user device. The radio terminal UE measures quality of a radio signal (i.e., radio quality) received from the radio base station eNB, and sends a report (referred to below as a measurement result report) on the result of radio quality measurement to the radio base station eNB to which the radio terminal UE connects.

Examples of such radio quality include reference signal received power (RSRP) and signal to interference and noise power ratio (SINR). A measurement result report on RSRP is referred to as a measurement report, while a measurement result report on an index of SINR for each of specific frequency bands is referred to as a CQI (Channel Quality Indicator).

The radio base station eNB to which the radio terminal UE connects performs handover control for switching a connection destination of the radio terminal UE according to a measurement report received from the radio terminal UE. In a case where the radio terminal UE receives reference signals from multiple radio base stations eNB, the measurement report includes multiple RSRPs of the multiple radio base stations eNB. The radio base station eNB to which the radio terminal UE connects normally selects the radio base station eNB having the highest RSRP among the multiple radio base stations eNB as the connection destination of the radio terminal UE.

Moreover, the radio base station eNB to which the radio terminal UE connects allocates resource blocks, each of which being a unit for radio resource allocation to the radio terminal UE, by referring to CQI received from the radio terminal UE. Moreover, the radio base station eNB to which the radio terminal UE connects determines a modulation class for use in radio communication with the radio terminal UE, by referring to the CQI received from the radio terminal UE. A modulation class is a combination of a modulation level and a coding rate.

The radio base stations eNB are capable of communicating with each other via an X2 interface being a logical communication path providing inter-base station communication. Each of the multiple radio base stations eNB can communicate with an EPC (Evolved Packet Core), namely, an MME (Mobility Management Entity) or an S-GW (Serving Gateway) via an S1 interface.

### (2) Configuration of Radio Communication System

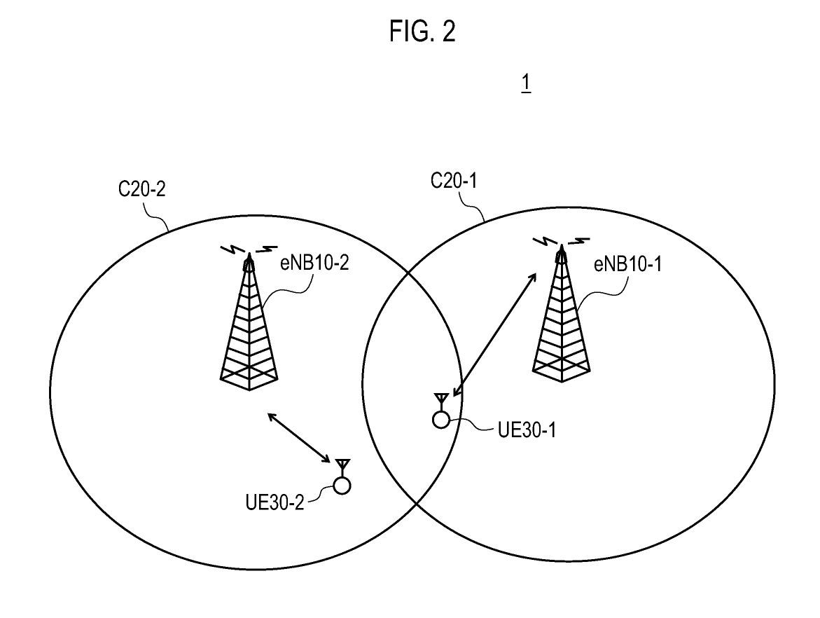

FIG. 2 is a schematic configuration diagram of a radio communication system 1 of this embodiment.

As shown in FIG. 2, the radio communication system 1 includes a radio base station eNB10-1, a radio terminal UE30-1 connecting to the radio base station eNB10-1 in a cell C20-1 formed by the radio base station eNB10-1, a radio base station eNB10-2, and a radio terminal UE30-2 connecting to the radio base station eNB10-2 in a cell C20-2 formed by the radio base station eNB10-2. The radio base station eNB10-1 and the radio base station eNB10-2 can perform inter-base station communication using the aforementioned X2 interface.

In this embodiment, the radio base station eNB10-1 serves as a first radio base station, and the radio base station eNB10-2 serves as a second radio base station. Note that although only one each of the radio terminal UE30-1 and the radio terminal UE30-2 is shown in FIG. 2, there are actually multiple radio terminals UE30-1 and multiple radio terminals UE30-2.

The radio communication system 1 supports aforementioned MLB. In this embodiment, each of the radio base stations eNB adjusts a handover parameter as a base station parameter defining coverage, according to load information exchanged between the radio base stations eNB. For example, when load of the radio base station eNB10-1 is higher than load of the radio base station eNB10-2, the radio base stations eNB adjust the handover parameters so that coverage of the radio base station eNB10-1 can be reduced and coverage of the radio base station eNB10-2 can be expanded.

In this embodiment, this handover parameter is an offset value for correcting the RSRP measured by the radio terminal UE. For example, assume a case where the radio terminal UE30-1 can receive radio signals from both of the radio base station eNB10-1 and the radio base station eNB10-2. Here, before comparing an RSRP (referred to below as RSRP1) of the radio base station eNB10-1 and an RSRP (referred to below as RSRP2) of the radio base station eNB10-2, an offset value for correcting RSRP2 to a higher value is added to RSRP2. This makes it more likely for the offset RSRP2 to exceed RSRP1. Accordingly, the radio base station eNB10-2 is preferentially selected as the connection destination (handover destination), and thus coverage of the radio base station eNB10-2 is expanded. Note that in order to avoid unnecessary handovers, one offset value is set for each pair of radio base stations eNB, and the value is shared between the paired radio base stations eNB.

### (3) Configuration of First Radio Base Station

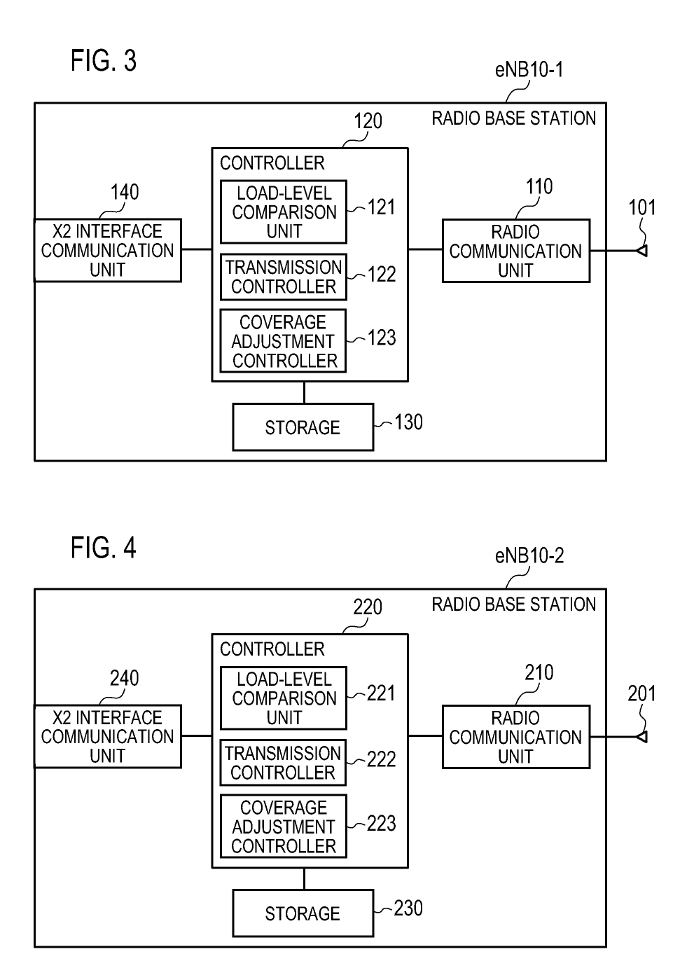

Next, a description is given of a configuration of the radio base station eNB10-1. FIG. 3 is a block diagram showing a configuration of the radio base station eNB10-1 of this embodiment.

As shown in FIG. 3, the radio base station eNB10-1 includes an antenna unit 101, a radio communication unit 110, a controller 120, a storage 130, and an X2 interface communication unit 140.

The antenna unit 101 is used to send and receive radio signals. The radio communication unit 110 is formed of a radio frequency (RF) circuit, a baseband (BB) circuit and the like, for example, and exchanges radio signals with the radio terminal UE via the antenna unit 101. In addition, the radio communication unit 110 modulates transmission signals, as well as demodulates reception signals.

The controller 120 is formed of a CPU, for example, and controls various functions of the radio base station eNB10-1. The storage 130 is formed of a memory, for example, and stores therein various kinds of information used for control and the like of the radio base station eNB10-1. The X2 interface communication unit 140 performs inter-base station communication with other radio base stations using the X2 interface.

The controller 120 includes a load-level comparison unit 121, a transmission controller 122, and a coverage adjustment controller 123.

The load-level comparison unit 121 detects the number of radio terminals UE30-1 connected to the radio base station eNB10-1. For example, the load-level comparison unit 121 can monitor states of allocation and release of time-frequency resources to and from the radio terminal UE30-1 by the radio base station eNB10-1, and detect the number of radio terminals UE30-1 from the monitoring result.

The load-level comparison unit 121 corrects a first threshold to be compared with a load level of the radio base station eNB10-1. Here, the fist threshold is a value defined as a load level at which the radio base station eNB10-1 can operate stably. The first threshold is set for each of types of load levels, and is stored in the storage 130. The load-level comparison unit 121 performs correction so that the smaller the number of radio terminals UE30-1 connected to the radio base station eNB10-1 is, the higher the first threshold is set. Note that as in the case of the first threshold before correction, the first threshold after correction is a load level at which the radio base station eNB10-1 can operate stably.

The load-level comparison unit 121 measures the load level of the radio base station eNB10-1. Here, load information (referred to below as first load information) indicating the load level of the radio base station eNB10-1 includes (a) usage of PRBs (Physical Resource Blocks), each of which being a unit for time-frequency resource allocation, (b) load of X2 interface between the radio base station eNB10-1 and a core network, (c) hardware load of the radio base station eNB10-1, and (d) capacity class being an index of relative communication capacity of the radio base station eNB10-1, and a ratio of available communication capacity to the communication capacity.

The load-level comparison unit 121 determines whether or not the measured load level of the radio base station eNB10-1 is equal to or higher than the corrected first threshold. Specifically, the load-level comparison unit 121 determines whether or not all types of load levels of the radio base station eNB10-1 are equal to or higher than the corresponding corrected first threshold for each load level, or whether or not an arbitrary type of load level of the radio base station eNB10-1 is equal to or higher than the corresponding corrected first threshold.

When the load level of the radio base station eNB10-1 is equal to or higher than the corrected first threshold, it is preferable that coverage of the radio base station eNB10-2 be expanded spuriously to reduce load of the radio base station eNB10-1. Meanwhile, when the load level of the radio base station eNB10-1 is lower than the corrected first threshold, load of the radio base station eNB10-1 need not be reduced, and thus coverage of the radio base station eNB10-2 need not be expanded spuriously.

When the load level of the radio base station eNB10-1 is equal to or higher than the corrected first threshold, the transmission controller 122 outputs a Resource Status Request message for requesting initiation of transmission of load information (referred to below as second load information) indicating the load level of the radio base station eNB10-2, to the X2 interface communication unit 140. In addition, the transmission controller 122 controls the X2 interface communication unit 140 so that the X2 interface communication unit 140 sends the Resource Status Request message for requesting initiation of transmission of the second load information to the radio base station eNB10-2.

Controlled by the transmission controller 122, the X2 interface communication unit 140 sends the Resource Status Request message for requesting initiation of transmission of the second load information to the radio base station eNB10-2 via the X2 interface.

The Resource Status Request message for requesting initiation of transmission of the second load information includes Registration Request which is information for requesting initiation of transmission of the second load information, Report Characteristics which is information indicating the type of second load information to send, and information indicating a transmission cycle of the second load information.

Meanwhile, when the load level of the radio base station eNB10-1 is lower than the corrected first threshold, the transmission controller 122 controls the X2 interface communication unit 140 so that the X2 interface communication unit 140 omits transmission of the Resource Status Request message for requesting initiation of transmission of the second load information.

Controlled by the transmission controller 122, the X2 interface communication unit 140 omits transmission of the Resource Status Request message for requesting initiation of transmission of the second load information.

Upon receipt of the Resource Status Request message for requesting initiation of transmission of the second load information, the radio base station eNB10-2 sends a Resource Status Response message or a Resource Status Failure message as a response, as will be described below. In a case of sending the Resource Status Response message, the radio base station eNB10-2 further sends Resource Status Update messages including the second load information at the transmission cycle included in the Resource Status Request message for requesting initiation of transmission of the second load information. At this time, the radio base station eNB10-2 sends the second load information to be included in the Resource Status Update message, the second load information including the type which corresponds to Report Characteristics, included in the Resource Status Request message for requesting initiation of transmission of the second load information.

The X2 interface communication unit 140 receives the Resource Status Response message or the Resource Status Failure message from the radio base station eNB10-2 via the X2 interface, and outputs the message to the load-level comparison unit 121. In a case of receiving the Resource Status Response message, the X2 interface communication unit 140 then periodically receives Resource Status Update messages including the second load information from the radio base station eNB10-2 via the X2 interface, and outputs the messages to the load-level comparison unit 121.

After input of the Resource Status Response message, the load-level comparison unit 121 measures the load level of the radio base station eNB10-1. Moreover, every time a Resource Status Update message including the second load information is inputted, the load-level comparison unit 121 determines whether or not the load level of the radio base station eNB10-2 is lower than the load level of the radio base station eNB10-1.

When the load level of the radio base station eNB10-2 is lower than the load level of the radio base station eNB10-1, the coverage adjustment controller 123 determines an offset value as a handover parameter to be added to RSRP2. Here, the offset value is a positive value.

The transmission controller 122 outputs a Mobility Change Request message including the offset value to the X2 interface communication unit 140. In addition, the transmission controller 122 controls the X2 interface communication unit 140 so that the X2 interface communication unit 140 sends the Mobility Change Request message including the offset value to the radio base station eNB10-2.

Controlled by the transmission controller 122, the X2 interface communication unit 140 sends the Mobility Change Request message including the offset value to the radio base station eNB10-2 via the X2 interface.

Upon receipt of the Mobility Change Request message, the radio base station eNB10-2 sends a Mobility Change Acknowledge message as a response, as will be described below.

The X2 interface communication unit 140 receives the

Mobility Change Acknowledge message from the radio base station eNB10-2 via the X2 interface, and outputs the message to the coverage adjustment controller 123. When the Mobility Change Acknowledge message is inputted, the coverage adjustment controller 123 sets an offset value as a handover parameter. The set offset value is stored in the storage 130.

Additionally, after the transmission controller 122 performs control so that the Resource Status Request message for requesting initiation of transmission of the second load information is sent to the radio base station eNB10-2, the following processing is performed simultaneously.

The load-level comparison unit 121 measures the load level of the radio base station eNB10-1. The load-level comparison unit 121 determines whether or not the measured load level of the radio base station eNB10-1 is lower than a second threshold. Here, the second threshold is a value smaller than the first threshold, set for each of types of the load levels, and is stored in the storage 130. The load-level comparison unit 121 determines whether or not all types of the load levels of the radio base station eNB10-1 are lower than the corresponding second thresholds, or whether or not an arbitrary type of the load level of the radio base station eNB10-1 is lower than the corresponding second threshold.

When the load level of the radio base station eNB10-1 is lower than the second threshold, load of the radio base station eNB10-1 need not be reduced, and thus the radio base station eNB10-1 need not acquire the second load information from the radio base station eNB10-2.

For this reason, when the load level of the radio base station eNB10-1 is lower than the second threshold, the transmission controller 122 outputs a Resource Status Request message for requesting stoppage of transmission of the second load information, to the X2 interface communication unit 140. Moreover, the transmission controller 122 controls the X2 interface communication unit 140 so that the X2 interface communication unit 140 sends the Resource Status Request message for requesting stoppage of transmission of the second load information to the radio base station eNB10-2. The Resource Status Request message for requesting stoppage of transmission of the second load information includes Registration Request which is information for requesting stoppage of transmission of the second load information.

Controlled by the transmission controller 122, the X2 interface communication unit 140 sends the Resource Status Request message for requesting stoppage of transmission of the second load information to the radio base station eNB10-2 via the X2 interface.

Upon receipt of the Resource Status Request message for requesting stoppage of transmission of the second load information, the radio base station eNB10-2 sends a Resource Status Response message as a response, as will be described below. The X2 interface communication unit 140 receives the Resource Status Response message from the radio base station eNB10-2 via the X2 interface, and outputs the message to the controller 120.

### (4) Configuration of Second Radio Base Station

Next, a description is given of a configuration of the radio base station eNB10-2. FIG. 4 is a block diagram showing the configuration of the radio base station eNB10-2 of this embodiment.

As shown in FIG. 4, the radio base station eNB10-2 includes an antenna unit 201, a radio communication unit 210, a controller 220, a storage 230, and an X2 interface communication unit 240.

The antenna unit 201 is used to send and receive radio signals. The radio communication unit 210 is formed of a radio frequency (RF) circuit, a baseband (BB) circuit and the like, for example, and exchanges radio signals with the radio terminal UE via the antenna unit 201. In addition, the radio communication unit 210 modulates transmission signals and demodulates reception signals.

The controller 220 is formed of a CPU, for example, and controls various functions of the radio base station eNB10-2. The storage 230 is formed of a memory, for example, and stores therein various kinds of information used for control and the like of the radio base station eNB10-2. The X2 interface communication unit 240 performs inter-base station communication with other radio base stations using the X2 interface.

The controller 220 includes a load-level comparison unit 221, a transmission controller 222, and a coverage adjustment controller 223.

The load-level comparison unit 221 measures the load level of the radio base station eNB10-2. Here, as in the case of the aforementioned first load information, load information (second load information) indicating the load level of the radio base station eNB10-2 includes (a) usage of PRBs (Physical Resource Blocks), each of which being a unit for time-frequency resource allocation, (b) load of X2 interface between the radio base station eNB10-2 and a core network, (c) hardware load of the radio base station eNB10-2, and (d) capacity class being an index of relative communication capacity of the radio base station eNB10-2, and a ratio of available communication capacity to the communication capacity.

The X2 interface communication unit 240 receives a Resource Status Request message for requesting initiation of transmission of the second load information from the radio base station eNB10-1 via the X2 interface, and outputs the message to the load-level comparison unit 221.

After receiving input of the Resource Status Request message for requesting initiation of transmission of the second load information, the load-level comparison unit 221 determines whether or not the measured load level of the radio base station eNB10-2 is lower than a third threshold. Here, the third threshold is set for each of types of the load levels, and is stored in the storage 230. Specifically, the load-level comparison unit 221 determines whether or not all types of the load levels of the radio base station eNB10-2 are lower than the corresponding third threshold for each load level, or whether or not an arbitrary type of load level of the radio base station eNB10-2 is lower than the corresponding third threshold.

When the load level of the radio base station eNB10-2 is equal to or higher than the third threshold, the transmission controller 222 outputs a Resource Status Failure message to the X2 interface communication unit 240, the message being a response indicating that the radio base station eNB10-1 cannot perform processing for reducing load of the radio base station eNB10-1. Moreover, the transmission controller 222 controls the X2 interface communication unit 240 so that the X2 interface communication unit 240 sends the Resource Status Failure message to the radio base station eNB10-1.

Controlled by the transmission controller 222, the X2 interface communication unit 240 sends the Resource Status Failure message to the radio base station eNB10-1 via the X2 interface.

Meanwhile, when the load level of the radio base station eNB10-2 is lower than the third threshold, the transmission controller 222 outputs a Resource Status Response message to the X2 interface communication unit 240, the message being a response indicating that the radio base station eNB10-1 can perform processing for reducing load of the radio base station eNB10-1. Moreover, the transmission controller 222 controls the X2 interface communication unit 240 so that the X2 interface communication unit 240 sends the Resource Status Response message to the radio base station eNB10-1.

Controlled by the transmission controller 222, the X2 interface communication unit 240 sends the Resource Status Response message to the radio base station eNB10-1 via the X2 interface.

After transmission of the Resource Status Response message, the load-level comparison unit 221 measures the load level of the radio base station eNB10-2.

The transmission controller 222 outputs a Resource Status Update message including the second load information indicating the measured load level of the radio base station eNB10-2 to the X2 interface communication unit 240. Moreover, the transmission controller 222 controls the X2 interface communication unit 240 so that the X2 interface communication unit 240 sends the Resource Status Update message including the second load information to the radio base station eNB10-1. At this time, the transmission controller 222 outputs the second load information to be included in the Resource Status Update messages to the X2 interface communication unit 240 at the transmission cycle included in the Resource Status Request message for requesting initiation of transmission of the second load information, the second load information including the type indicated by Report Characteristics included in the Resource Status Request message for requesting initiation of transmission of the second load information.

Controlled by the transmission controller 222, the X2 interface communication unit 240 sends the Resource Status Update message including the second load information to the radio base station eNB10-1 via the X2 interface.

Thereafter, the X2 interface communication unit 240 receives a Mobility Change Request message including an offset value from the radio base station eNB10-1 via the X2 interface, and outputs the message to the coverage adjustment controller 223.

The transmission controller 222 outputs a Mobility Change Acknowledge message as a response to the Mobility Change Request message to the X2 interface communication unit 240, and controls the X2 interface communication unit 240 so that the X2 interface communication unit 240 sends the Mobility Change Acknowledge message to the radio base station eNB10-1.

Controlled by the transmission controller 222, the X2 interface communication unit 240 sends the Mobility Change Acknowledge message to the radio base station eNB10-1 via the X2 interface.

The coverage adjustment controller 223 stores the offset value as a handover parameter included in the Mobility Change Request message to the storage 230. Thus, the offset value as the handover parameter is shared between the radio base station eNB10-1 and the radio base station eNB10-2, so that RSRP1 and RSRP2 to which the offset value is added are compared to each other in handover control. Accordingly, coverage of the radio base station eNB10-2 is expanded spuriously.

Additionally, after the load-level comparison unit 221 receives a Resource Status Request message for requesting initiation of transmission of the second load information, the following processing is performed simultaneously.

The X2 interface communication unit 240 receives a Resource Status Request message for requesting stoppage of transmission of the second load information, from the radio base station eNB10-1 via the X2 interface, and outputs the message to the transmission controller 222.

The transmission controller 222 outputs a Resource Status Response message as a response to the Resource Status Request message for requesting stoppage of transmission of the second load information, to the X2 interface communication unit 240. The transmission controller 222 then controls the X2 interface communication unit 240 so that the X2 interface communication unit 240 sends the Resource Status Response message to the radio base station eNB10-1.

Controlled by the transmission controller 222, the X2 interface communication unit 240 sends the Resource Status Response message to the radio base station eNB10-1 via the X2 interface.

When the Resource Status Request message for requesting stoppage of transmission of the second load information is inputted, the transmission controller 222 controls the X2 interface communication unit 240 so that the X2 interface communication unit 240 stops transmission of a Resource Status Update message including the second load information. Controlled by the transmission controller 222, the X2 interface communication unit 240 stops transmission of the Resource Status Update message.

### (5) Operation of Radio Communication System

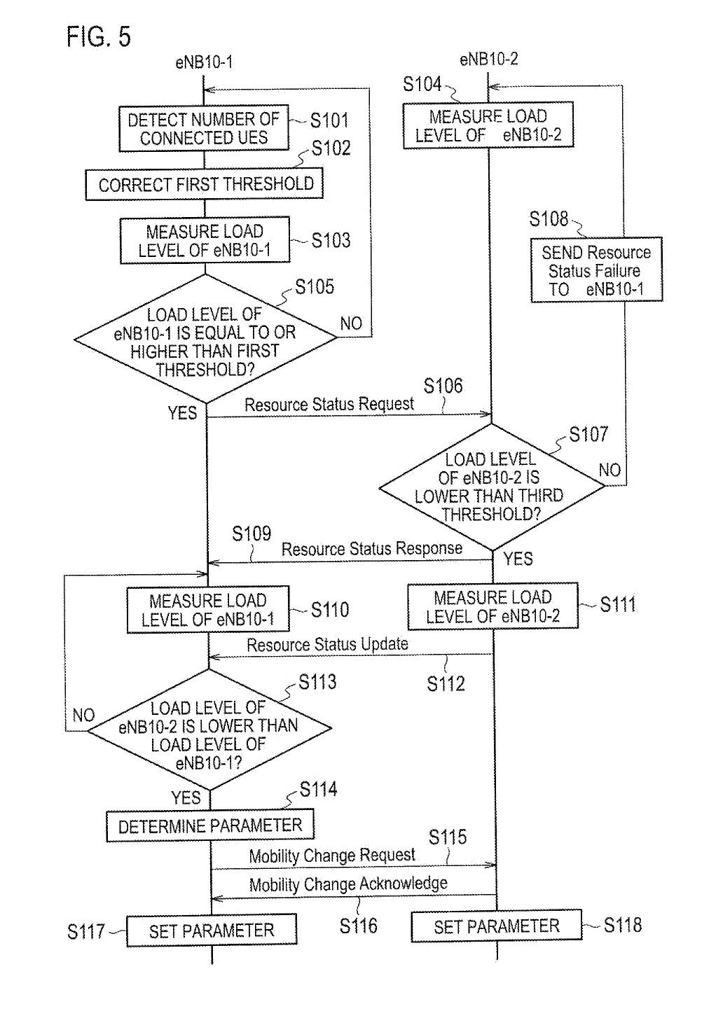

FIG. 5 is an operation sequence chart showing a first operation of the radio communication system 1 of this embodiment.

In step S101, the load-level comparison unit 121 of the radio base station eNB10-1 detects the number of radio terminals UE30-1 connected to the radio base station eNB10-1. In step S102, the load-level comparison unit 121 of the radio base station eNB10-1 corrects the first threshold according to the number of the radio terminals UE30-1 connected to the radio base station eNB10-1.

In step S103, the load-level comparison unit 121 of the radio base station eNB10-1 measures the load level of the radio base station eNB10-1. In step S104, the load-level comparison unit 221 of the radio base station eNB10-2 measures the load level of the radio base station eNB10-2.

In step S105, the load-level comparison unit 121 of the radio base station eNB10-1 determines whether or not the load level of the radio base station eNB10-1 is equal to or higher than the first threshold. When the load level of the radio base station eNB10-1 is lower than the first threshold, step S101 and following steps are repeated.

Meanwhile, when the load level of the radio base station eNB10-1 is equal to or higher than the first threshold, in step S106, the transmission controller 122 of the radio base station eNB10-1 controls the X2 interface communication unit 140 so that the X2 interface communication unit 140 sends a Resource Status Request message for requesting initiation of transmission of the second load information, to the radio base station eNB10-2. The interface communication unit 240 of the radio base station eNB10-2 receives the Resource Status Request message for requesting initiation of transmission of the second load information.

In step S107, the load-level comparison unit 221 of the radio base station eNB10-2 determines whether or not the load level of the radio base station eNB10-2 is lower than the third threshold. When the load level of the radio base station eNB10-2 is equal to or higher than the third threshold, in step S108, the transmission controller 222 of the radio base station eNB10-2 controls the X2 interface communication unit 240, and the X2 interface communication unit 240 sends a Resource Status Failure message to the radio base station eNB10-1. The X2 interface communication unit 140 of the radio base station eNB10-1 receives the Resource Status Failure message. Thereafter, step S104 and following steps are repeated.

Meanwhile, when the load level of the radio base station eNB10-2 is lower than the third threshold, in step S109, the transmission controller 222 of the radio base station eNB10-2 controls the X2 interface communication unit 240, and the X2 interface communication unit 240 sends a Resource Status Response message to the radio base station eNB10-1. The X2 interface communication unit 140 of the radio base station eNB10-1 receives the Resource Status Response message.

After the transmission and reception of the Resource Status Response message in step S109, in step S110, the load-level comparison unit 121 of the radio base station eNB10-1 measures the load level of the radio base station eNB10-1. In step S111, the load-level comparison unit 221 of the radio base station eNB10-2 measures the load level of the radio base station eNB10-2.

In step S112, the transmission controller 222 of the radio base station eNB10-2 controls the X2 interface communication unit 240, and the X2 interface communication unit 240 periodically sends Resource Status Update messages including the second load information, to the radio base station eNB10-1. The X2 interface communication unit 140 of the radio base station eNB10-1 receives the Resource Status Update messages including the second load information.

In step S113, the load-level comparison unit 121 of the radio base station eNB10-1 determines whether or not the load level of the radio base station eNB10-2 indicated by the second load information is lower than the load level of the radio base station eNB10-1. When the load level of the radio base station eNB10-2 is equal to or higher than the load level of the radio base station eNB10-1, step S110 and following steps are repeated.

Meanwhile, when the load level of the radio base station eNB10-2 is lower than the load level of the radio base station eNB10-1, in step S114, the coverage adjustment controller 123 of the radio base station eNB10-1 determines an offset value as a handover parameter to be added to RSRP2.

In step S115, the transmission controller 122 of the radio base station eNB10-1 controls the X2 interface communication unit 140, and the X2 interface communication unit 140 sends a Mobility Change Request message including the offset value to the radio base station eNB10-2. The X2 interface communication unit 240 of the radio base station eNB10-2 receives the Mobility Change Request message including the offset value.

In step S116, the transmission controller 222 of the radio base station eNB10-2 controls the X2 interface communication unit 240, and the X2 interface communication unit 240 sends a Mobility Change Acknowledge message to the radio base station eNB10-1. The X2 interface communication unit 140 of the radio base station eNB10-1 receives the Mobility Change Acknowledge message.

In step S117, the coverage adjustment controller 123 of the radio base station eNB10-1 sets the offset value as the handover parameter. In step S118, the coverage adjustment controller 223 of the radio base station eNB10-2 sets the offset value as the handover parameter included in the Mobility Change Request message in the storage 230.

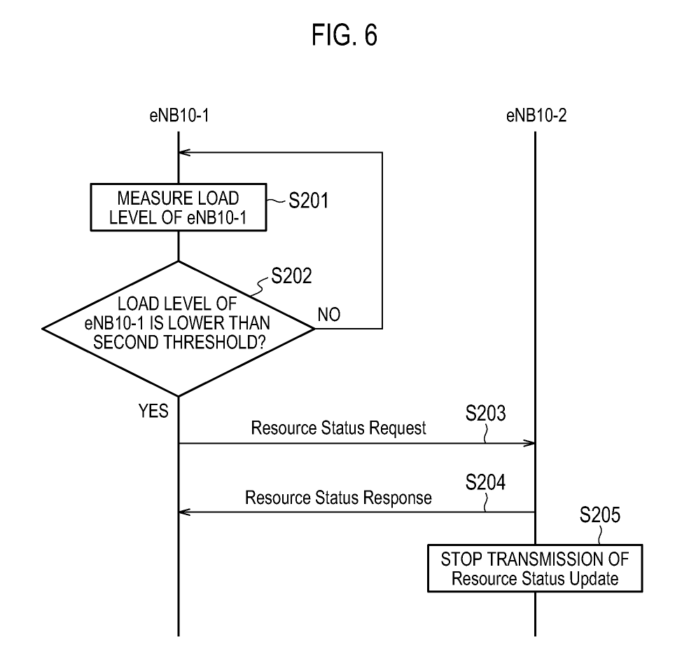

FIG. 6 is an operation sequence chart showing a second operation of the radio communication system 1 of this embodiment. The second operation is executed in parallel with the first operation after step S106 of the first operation in FIG. 5.

In step S201, the load-level comparison unit 121 of the radio base station eNB10-1 measures the load level of the radio base station eNB10-1. In step S202, the load-level comparison unit 121 of the radio base station eNB10-1 determines whether or not the load level of the radio base station eNB10-1 is lower than the second threshold. When the load level of the radio base station eNB10-1 is equal to or higher than the second threshold, step S201 and following steps are repeated.

Meanwhile, when the load level of the radio base station eNB10-1 is lower than the second threshold, in step S203, the transmission controller 122 of the radio base station eNB10-1 controls the X2 interface communication unit 140, and the X2 interface communication unit 140 sends a Resource Status Request message for requesting stoppage of transmission of the second load information, to the radio base station eNB10-2. The X2 interface communication unit 240 of the radio base station eNB10-2 receives the Resource Status Request message for requesting stoppage of transmission of the second load information.

In step S204, the transmission controller 222 of the radio base station eNB10-2 controls the X2 interface communication unit 240, and the X2 interface communication unit 240 sends a Resource Status Response message to the radio base station eNB10-1. The X2 interface communication unit 140 of the radio base station eNB10-1 receives the Resource Status Response message.

In step S205, the transmission controller 222 of the radio base station eNB10-2 controls the X2 interface communication unit 240, and the X2 interface communication unit 240 stops transmission of the Resource Status Update message including the second load information.

### (6) Effects and Advantages

As has been described, according to this embodiment, the radio base station eNB10-1: sends a Resource Status Request message for requesting initiation of transmission of the second load information, to the radio base station eNB10-2 when its own load level is equal to or higher than the first threshold; and omits transmission of the Resource Status Request message for requesting initiation of transmission of the second load information when its own load level is lower than the first threshold. Meanwhile, upon receipt of the Resource Status Request message for requesting initiation of transmission of the second load information, the radio base station eNB10-2 sends a Resource Status Update message including the second load information, to the radio base station eNB10-1. Accordingly, when the load level of the radio base station eNB10-1 is low and coverage of the radio base station eNB10-2 need not be expanded spuriously, the Resource Status Request message for requesting transmission of the second load information and the Resource Status Update message including the second load information are not exchanged. Hence, load of the X2 interface between the radio base station eNB10-1 and the radio base station eNB10-2 can be reduced.

According to this embodiment, the radio base station eNB10-1 corrects a first threshold so that the first threshold is made higher when the number of radio terminals UE30-1 connected thereto is small. If the load level of the radio base station eNB10-1 is high even though only a small number of the radio terminals UE are connected thereto, this means that a single radio terminal UE provides large load to the radio base station eNB10-1. In this case, if coverage of the radio base station eNB10-2 is expanded spuriously, load of the radio base station eNB10-2 to which the radio terminal UE is newly connected may be increased excessively. Accordingly, the first threshold is corrected to a higher value when the number of the radio terminals UE30-1 connected to the radio base station eNB10-1 is small. Thus, the smaller the number of the radio terminals UE30-1 connected to the radio base station eNB10-1 is, the more likely that transmission by the radio base station eNB10-1 of the Resource Status Request message for requesting initiation of transmission of the second load information is omitted. As a result, coverage of the radio base station eNB10-2 is less likely to be expanded, so that an excessive increase in load of the radio base station eNB10-2 can be prevented.

According to this embodiment, the radio base station eNB10-1 sends a Resource Status Request message for requesting stoppage of transmission of the second load information to the radio base station eNB10-2 when its own load level is lower than the second threshold. Meanwhile, upon receipt of the Resource Status Request message for requesting stoppage of transmission of the second load information, the radio base station eNB10-2 stops transmission of the Resource Status Update message including the second load information. Accordingly, by stopping transmission of the second load information when load of the radio base station eNB10-1 is reduced and the second load information is unnecessary, load of the X2 interface between the radio base station eNB10-1 and the radio base station eNB10-2 can be reduced.

### (7) Other Embodiments

As mentioned above, the present invention has been described according to the embodiment. However, it should not be understood that the discussions and the drawings constituting a part of this disclosure limit the present invention. From this disclosure, various alternative embodiments, examples and operational techniques will be apparent to those skilled in the art.

Although the radio base station eNB10-1 of the above embodiment sets an offset value to be added to RSRP2, the radio base station eNB10-1 may instead set an offset value to be subtracted from RSRP1. Alternatively, the radio base station eNB10-1 may set an offset value to be subtracted from RSRP1 in addition to setting the offset value to be added to RSRP2.

Although the radio base station eNB10-1 of the above embodiment corrects the first threshold according to the number of radio terminals UE30-1 connected thereto, this correction may be omitted.

Although the above embodiment includes only a single radio base station eNB10-2, other embodiments may include multiple radio base stations eNB10-2. In such a case, the transmission controller 122 of the radio base station eNB10-1 may perform control so that a Resource Status Request message for requesting initiation of transmission of the second load information is sent only to certain radio base stations eNB10-2 among the multiple radio base stations eNB10-2. For example, the transmission controller 122 performs control so that the propagation loss (path loss) between the radio base station eNB10-1 and each of the radio base stations eNB10-2 is acquired, and transmission of the Resource Status Request message to the radio base station eNB10-2 falling short of a predetermined value is omitted. In this case, it is possible to prevent unnecessary transmission of the Resource Status Request message to the radio base station eNB10-2 which is located far from the radio base station eNB10-1 and which is less likely to reduce load of the radio base station eNB10-1. Hence, load of the X2 interface is reduced.

Moreover, upon receipt of the second load information from each of the multiple radio base stations eNB10-2, the load-level comparison unit 121 of the radio base station eNB10-1 may calculate an average value of the load levels indicated by the second load information, and determine whether or not load of the radio base station eNB10-1 is lower than the average value.

Although load information is included in a Resource Status Update message in the above embodiment, it may instead be included in a Resource Status Response message being a response to a request for load information.

Although the radio communication system 1 is formed of the radio base station eNB10-1 and the radio base station eNB10-2 in the above embodiment, the present invention is also applicable to a radio communication system formed of a macrocell base station MeNB and a picocell base station PeNB.

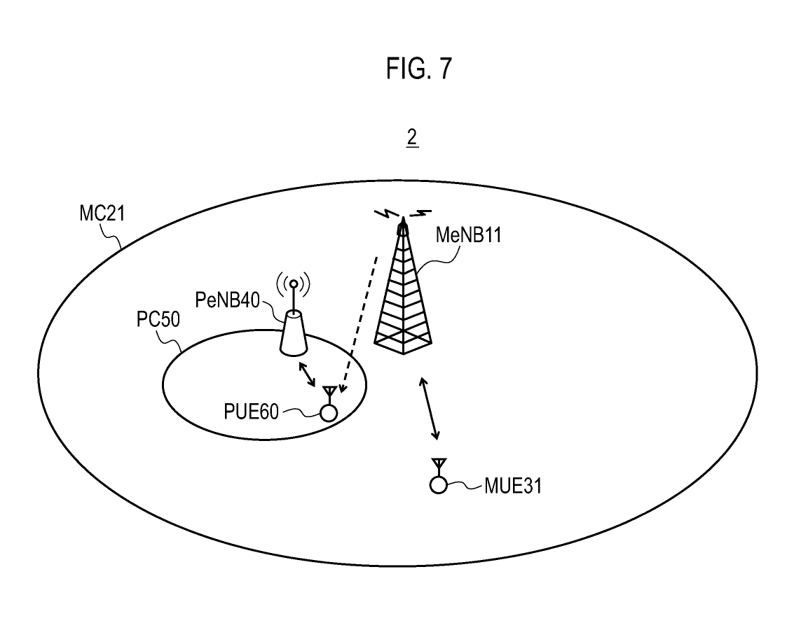

FIG. 7 is a schematic configuration diagram of a radio communication system 2 of another embodiment. As shown in FIG. 7, in the radiocommunication system 2, radio base stations form a heterogeneous network arrangement. The radio communication system 2 includes a macrocell base station MeNB11, a radio terminal MUE31 connecting to the macrocell base station MeNB11, a picocell base station PeNB40 located in a macrocell MC21 formed by the macrocell base station MeNB11 and adjacent to the macrocell base station MeNB11, and a radio terminal PUE60 connecting to the picocell base station PeNB40 in a picocell PC50 formed by the picocell base station PeNB40. The macrocell base station MeNB11 and the picocell base station PeNB40 can perform inter-base station communication using an X2 interface.

In the radio communication system 2 shown in FIG. 7, the macrocell base station MeNB11 performs the same processing as the radio base station eNB10-1 in FIG. 1, and the picocell base station PeNB40 performs the same processing as the radio base station eNB10-2 in FIG. 1. Alternatively, the picocell base station PeNB40 performs the same processing as the radio base station eNB10-1 in FIG. 1, and the macrocell base station MeNB11 performs the same processing as the radio base station eNB10-2 in FIG. 1.

Note that in LTE Advanced, use of a relay node being a radio base station forming a backhaul by radio waves is planned, and use of an X2 interface for the relay node is also planned. Accordingly, such a relay node may be used as a second radio base station of the present invention.

Although the above embodiment has been described using a case where the backhaul is an X2 interface, the present invention is similarly applicable to a case where the backhaul is an S1 interface or a case where the backhaul includes both an X2 interface and an S1 interface. When the backhaul is an S1 interface, each radio base station eNB is provided with an S1 interface communication unit.

Furthermore, although the above embodiment has been described using an LTE system, the present invention is also applicable to other radio communication systems such as a radio communication system according to WiMAX (IEEE 802.16).

As mentioned above, it should be understood that the present invention includes various embodiments and the like which are not described herein.

Note that the entire content of the Japanese Patent Application No. 2010-122141 (filed on May 27, 2010) is incorporated herein by reference.

### INDUSTRIAL APPLICABILITY

As mentioned above, the radio communication system, the radio base station, and a communication control method is useful for radio communication such as mobile communication, by which load in the transmission paths between the radio base stations can be reduced.

1. A radio communication system comprising a first radio base station and a second radio base station each being capable of adjusting coverage according to its own load and load of the other radio base station,
the first radio base station comprising:
a first transmitter configured to send, to the second radio base station, load request information for requesting load information indicating a load level of the second radio base station; and
a first transmission controller configured to control the first transmitter, wherein
the first transmission controller controls the first transmitter so that the load request information is sent to the second radio base station when a load level of the first radio base station is equal to or higher than a first threshold, and controls the first transmitter so that transmission of the load request information to the second radio base station is omitted when the load level of the first radio base station is lower than the first threshold,
the second radio base station comprising:
a second transmitter configured to send, to the first radio base station, the load information indicating the load level of the second radio base station; and
a second transmission controller configured to control the second transmitter, wherein
upon receipt of the load request information, the second transmission controller controls the second transmitter to send the load information to the first radio base station.

2. A radio base station capable of adjusting coverage according to its own load and load of other radio base station, comprising:
a transmitter configured to send, to the other radio base station, load request information for requesting load information indicating a load level of the other radio base station; and
a transmission controller configured to control the transmitter, wherein
the transmission controller controls the transmitter so that the load request information is sent to the other radio base station when its own load level is equal to or higher than a first threshold, and controls the transmitter so that transmission of the load request information to the other radio base station is omitted when its own load level is lower than the first threshold.

3. The radio base station according to claim 2, wherein the first threshold is a value lower than a load level at which the radio base station is stably operable.

4. The radio base station according to claim 2, wherein the smaller the number of radio terminals connected to the radio base station is, the higher the transmission controller sets the first threshold is.

5. The radio base station according to claim 2, wherein when the load level of the radio base station becomes lower than a second threshold after transmission of the load request information, the transmission controller controls the transmitter to send stoppage request information for requesting stoppage of transmission of the load information to the other radio base station.

6. A communication control method used by a radio base station capable of adjusting coverage according to its own load and load of other radio base station, comprising the steps of:
sending, to the other radio base station, load request information for requesting load information indicating a load level of the other radio base station; and
controlling transmission of the load request information, wherein
in the step of controlling transmission of the load request information, the control is performed so that the load request information is sent to the other radio base station when the load level of the radio base station is equal to or higher than a first threshold, and the control is performed so that transmission of the load request information to the other radio base station is omitted when the load level of the radio base station is lower than the first threshold.
